(19) United States
(12) Patent Application Publication
(10) Pub. No.: US 2026/0195120 A1
(43) Pub. Date: Jul. 9, 2026

(54) BUILDING A TUNABLE SIZING MODEL FOR SOFTWARE SIZING RECOMMENDATION

(71) Applicant: International Business Machines Corporation, Armonk, NY (US)

(72) Inventors: Ying Mo, Beijing (CN); Xing Tian, Beijing (CN); Wu Di, Beijing (CN); QING ZHI YU, Beijing (CN); Jing Wen HC Cui, Beijing (CN); Ju Ling Liu, Beijing (CN); HUI GUANG LIU, Beijing (CN); Nan Chen, Beijing (CN)

(21) Appl. No.: 19/011,702

(22) Filed: Jan. 7, 2025

(51) Int. Cl. G06F 8/71

(52) U.S. Cl. CPC G06F 8/71

(57) ABSTRACT

Embodiments of the disclosure include a method for building a tunable sizing model for software sizing recommendation to operate on computer systems. The method includes building a sizing machine learning model that is trained in accordance with an output of a sizing application. The sizing machine learning model is further trained with data of a target system. The sizing machine learning model is configured to output a sizing result for a software. The method includes executing the sizing machine learning model based on feedback from the target system to output the sizing result. The method includes causing the software to be modified according to the sizing result, the software being configured for execution on the target system.

### BACKGROUND

The present disclosure generally relates to computer systems, and more specifically, to computer-implemented methods, computer systems, and computer program products configured and arranged to build a tunable sizing model for outputting a software sizing recommendation to modify software to operate on computer systems.

Customers may have issues about the performance of a software product when they use it because the software product is not in accord with the computer resources of the target system.

A software sizing application is a tool used to provide recommendations on the resources required to support specified workloads or to determine the workloads that can be supported given specified resources. Software sizing applications are used for planning and optimizing the deployment of software systems, ensuring that they operate efficiently and within the constraints of available resources. Although techniques for tunning the size of software exist, improvements can be made that account for more factors.

### SUMMARY

Embodiments of the disclosure include a method for building a tunable sizing model for outputting a software sizing recommendation to modify software to operate on computer systems. The method includes building a sizing machine learning model that is trained in accordance with an output of a sizing application, where the sizing machine learning model is further trained with data of a target system, where the sizing machine learning model is configured to output a sizing result for a software. The method includes executing the sizing machine learning model based on feedback from the target system to output the sizing result. Also, the method includes causing the software to be modified according to the sizing result, the software being configured for execution on the target system.

The above features and advantages, and other features and advantages, of the disclosure are readily apparent from the following detailed description when taken in connection with the accompanying drawings.

### BRIEF DESCRIPTION OF THE DRAWINGS

FIG. 1 illustrates a computing environment for executing methods related to building a tunable sizing machine learning model for outputting a software sizing recommendation to modify software to operate on computer systems in accordance with one or more embodiments.

FIG. 2 illustrates a block diagram of a method for building a tunable sizing model for outputting a software sizing recommendation to modify software to operate on computer systems in accordance with one or more embodiments.

FIG. 3A illustrates a flow diagram for building a sizing machine learning model in accordance with one or more embodiments.

FIG. 3B illustrates a flow diagram for using a sizing machine learning model in accordance with one or more embodiments.

FIG. 4 illustrates an example flow diagram of a procedure for building the sizing machine learning model to fit the sizing application in accordance with one or more embodiments.

FIG. 5 illustrates example details regarding an acquisition function in accordance with one or more embodiments.

FIGS. 6A and 6B illustrate example details regarding a search space and prior samples when building the sizing machine learning model to fit the sizing application in accordance with one or more embodiments.

FIG. 7 illustrates an example of introducing a bias parameter into a sizing machine learning model during the building phase in accordance with one or more embodiments.

FIG. 8A illustrates graphs with three-dimensional (3D) vectors impacted by the bias parameter in accordance with one or more embodiments.

FIG. 8B illustrates an example of prior samples with values for the bias parameter in accordance with one or more embodiments.

FIG. 9 illustrates a graph depicting sizing results of the sizing application and the sizing machine learning model and an aggregation of the sizing results when using the model in accordance with one or more embodiments.

FIG. 10A illustrates a block diagram of example details regarding executing the sizing machine learning model in accordance with one or more embodiments.

FIG. 10B illustrates an example search space definition when executing the sizing machine learning model in accordance with one or more embodiments.

FIG. 10C illustrates an example sizing request payload with a bias parameter when executing the sizing machine learning model in accordance with one or more embodiments

FIG. 11 illustrates a flowchart of a computer-implemented method for operating the sizing machine learning model with a model runner module in accordance with one or more embodiments.

FIG. 12 illustrates a block diagram of a pipeline for maintaining/updating the sizing machine learning model in accordance with one or more embodiments.

FIG. 13 is a flowchart of a computer-implemented method for building a tunable sizing machine learning model for outputting a software sizing recommendation to modify software on a target system in accordance with one or more embodiments.

The above features and advantages, and other features and advantages, of the disclosure are readily apparent from the following detailed description when taken in connection with the accompanying drawings.

### DETAILED DESCRIPTION

According to one or more embodiments, a computer-implemented method includes building a sizing machine learning model that is trained in accordance with an output of a sizing application, where the sizing machine learning model is further trained with data of a target system, where the sizing machine learning model is configured to output a sizing result for a software. The method includes executing the sizing machine learning model based on feedback from the target system to output the sizing result. The method includes causing the software to be modified according to the sizing result, the software being configured for execution on the target system. Technical effects and solutions enhance adaptability by allowing for a more accurate and adaptable sizing recommendation. This dual training approach ensures that the sizing machine learning model can incorporate real-world data and feedback, which enhance its ability to provide relevant and precise sizing results tailored to specific environments. Technical effects provide continuous improvement and refinement of the sizing recommendations using the feedback, which allows the sizing machine learning model to adjust its predictions dynamically, ensuring that the sizing recommendations remain accurate and effective as the target system evolves over time. Further, technical effects and solutions optimize computer resource utilization by ensuring that the software is optimized for the specific resources and constraints of the target system; this targeted modification improves the efficiency and performance of the software, reduces the likelihood of resource overuse or underutilization, and ultimately leads to better system performance, faster response times, better handling of workloads, and an improved user experience. The technical effects and solutions reduce manual intervention thereby affording a more streamlined and efficient deployment process.

In addition to one or more of the features described above or below, additional features disclose the sizing machine learning model receives input of a bias parameter. Technical effects and solutions provide greater flexibility in adjusting the model's behavior. This enables the model to be fine-tuned based on specific requirements or preferences, allowing for more customized and accurate sizing recommendations.

In addition to one or more of the features described above or below, additional features disclose a bias parameter indicates a confidence when incorporating the feedback from the target system into the sizing machine learning model. Technical effects and solutions improve the model's accuracy because the bias parameter can be used to incorporate varying levels of confidence in the data sources, such as customer inputs or historical data, thereby refining the model's predictions, leading to more reliable sizing results.

In addition to one or more of the features described above or below, additional features disclose the sizing result includes dimensions that are associated with execution of the software. Technical effects and solutions ensure that all relevant factors are considered when making sizing recommendations to modify the software. This leads to more accurate and effective resource allocation, optimizing the performance of the software on the target system.

In addition to one or more of the features described above or below, additional features disclose the sizing result include dimensions that correspond to a modification to the software in order to change an amount of computer resources required by the target system to execute the software. Technical effects and solutions ensure that the software is tailored to efficiently use the available computer resources of the target system, leading to improved performance and reduced resource wastage.

In addition to one or more of the features described above or below, additional features disclose: the feedback from the target system is configured to modify the sizing result output from the sizing machine learning model to meet computer resources of the target system, and logic of the sizing application is hard-coded. Technical effects and solutions allow for real-time adjustments to the sizing recommendations. This ensures that the software remains optimized for the current resource conditions of the target system.

In addition to one or more of the features described above or below, additional features disclose: the sizing application outputs a second sizing result such that an error rate is a difference between the sizing result and the second sizing result, and the sizing result is selected in response to the error rate meeting an allowed error rate. Technical effects and solutions ensure that the final sizing recommendation is accurate and reliable, where this comparison validates the sizing result against a known baseline. The use of an allowed error rate provides a mechanism to control the tolerance for discrepancies between the sizing results.

According to one or more embodiments, a system includes: a memory comprising computer readable instructions, and a processing device for executing the computer readable instructions, the computer readable instructions controlling the processing device to perform operations. The operations include building a sizing machine learning model that is trained in accordance with an output of a sizing application, where the sizing machine learning model is further trained with data of a target system, where the sizing machine learning model is configured to output a sizing result for a software. The operations include executing the sizing machine learning model based on feedback from the target system to output the sizing result. The operations include causing the software to be modified according to the sizing result, the software being configured for execution on the target system.

In addition to one or more of the features described above or below, additional features disclose the sizing machine learning model receives input of a bias parameter. Technical effects and solutions provide greater flexibility in adjusting the model's behavior. This enables the model to be fine-tuned based on specific requirements or preferences, allowing for more customized and accurate sizing recommendations.

In addition to one or more of the features described above or below, additional features disclose a bias parameter indicates a confidence when incorporating the feedback from the target system into the sizing machine learning model. Technical effects and solutions improve the model's accuracy because the bias parameter can be used to incorporate varying levels of confidence in the data sources, such as customer inputs or historical data, thereby refining the model's predictions, leading to more reliable sizing results.

In addition to one or more of the features described above or below, additional features disclose the sizing result includes dimensions that are associated with execution of the software. Technical effects and solutions ensure that all relevant factors are considered when making sizing recommendations to modify the software. This leads to more accurate and effective resource allocation, optimizing the performance of the software on the target system.

In addition to one or more of the features described above or below, additional features disclose the sizing result include dimensions that correspond to a modification to the software in order to change an amount of computer resources required by the target system to execute the software. Technical effects and solutions ensure that the software is tailored to efficiently use the available computer resources of the target system, leading to improved performance and reduced resource wastage.

In addition to one or more of the features described above or below, additional features disclose: the feedback from the target system is configured to modify the sizing result output from the sizing machine learning model to meet computer resources of the target system, and logic of the sizing application is hard-coded. Technical effects and solutions allow for real-time adjustments to the sizing recommendations. This ensures that the software remains optimized for the current resource conditions of the target system.

In addition to one or more of the features described above or below, additional features disclose: the sizing application outputs a second sizing result such that an error rate is a difference between the sizing result and the second sizing result, and the sizing result is selected in response to the error rate meeting an allowed error rate. Technical effects and solutions ensure that the final sizing recommendation is accurate and reliable, where this comparison validates the sizing result against a known baseline. The use of an allowed error rate provides a mechanism to control the tolerance for discrepancies between the sizing results.

According to one or more embodiments, a computer program product includes a set of one or more computer-readable storage media, and program instructions, collectively stored in the set of one or more storage media, for causing a processor set to perform computer operations. The computer operations include building a sizing machine learning model that is trained in accordance with an output of a sizing application, where the sizing machine learning model is further trained with data of a target system, where the sizing machine learning model is configured to output a sizing result for a software. The computer operations include executing the sizing machine learning model based on feedback from the target system to output the sizing result. The computer operations include causing the software to be modified according to the sizing result, the software being configured for execution on the target system.

In addition to one or more of the features described above or below, additional features disclose the sizing machine learning model receives input of a bias parameter. Technical effects and solutions provide greater flexibility in adjusting the model's behavior. This enables the model to be fine-tuned based on specific requirements or preferences, allowing for more customized and accurate sizing recommendations.

In addition to one or more of the features described above or below, additional features disclose a bias parameter indicates a confidence when incorporating the feedback from the target system into the sizing machine learning model. Technical effects and solutions improve the model's accuracy because the bias parameter can be used to incorporate varying levels of confidence in the data sources, such as customer inputs or historical data, thereby refining the model's predictions, leading to more reliable sizing results.

In addition to one or more of the features described above or below, additional features disclose the sizing result includes dimensions that are associated with execution of the software. Technical effects and solutions ensure that all relevant factors are considered when making sizing recommendations to modify the software. This leads to more accurate and effective resource allocation, optimizing the performance of the software on the target system.

In addition to one or more of the features described above or below, additional features disclose the sizing result include dimensions that correspond to a modification to the software in order to change an amount of computer resources required by the target system to execute the software. Technical effects and solutions ensure that the software is tailored to efficiently use the available computer resources of the target system, leading to improved performance and reduced resource wastage.

In addition to one or more of the features described above or below, additional features disclose: the feedback from the target system is configured to modify the sizing result output from the sizing machine learning model to meet computer resources of the target system, and logic of the sizing application is hard-coded. Technical effects and solutions allow for real-time adjustments to the sizing recommendations. This ensures that the software remains optimized for the current resource conditions of the target system.

One or more embodiments are configured and arranged for building a tunable sizing model for outputting a software sizing recommendation to modify software to operate on computer systems. A sizing application is an application used to provide a sizing suggestion for a software based on user requirements, and the sizing suggestion may, for example, provide an estimation about how many computer resources are needed to support the specified workloads or how many workloads can be supported given the specified resources.

However, the existing sizing applications are mostly based on white-box knowledge, and the usual problems for existing sizing applications are as below:

1) The sizing logic is hard-coded. The sizing for the target system is built based on a model that is hard-coded into a software program of the sizing application. Any adjustment to the model may involve a code change of the sizing application. An example of the reason the model might need to be adjusted is because the suggested sizing generated by the sizing application is unacceptable to customers as the software requires too many computer resources, which makes it difficult for customers with a restricted budget to adopt the software. In this scenario, it would be beneficial to check if the model can be adjusted, for example, to be a bit more aggressive to use less computer resources when making the sizing estimation without having to change the code of the sizing application, as discussed in accordance with one or more embodiments.

2) Lack of effective feedback loop from the customer to the sizing application. Some customers may have already deployed a target system with the software and run the target system for a considerable period. Such a customer has strong evidence about how many computer resources are needed to support their workloads, but the sizing application is often built based on a simulated environment setup in a laboratory. The sizing application does not support the feedback loop from the customer, so the model cannot be easily adjusted according to the evidence collected from customer's real environment without going through the code change process. In this scenario, it would be beneficial to make efficient use of such real environment data scattered among many different customers, in order improve the sizing application, as discussed in accordance with one or more embodiments. This provides a way to build a sizing application more effectively, considering the effort of constantly maintaining a set of testing environments in laboratory for regular performance evaluation.

To address these and/or other shortcomings, one or more embodiments are configured to build a sizing machine learning model to fit/use the existing sizing application as a base or input. Particularly, the sizing machine learning model is tuned by incorporating the data collected from customer environment along with the data retrieved from that sizing application in order to adjust the sizing machine learning model. One or more embodiments can use a bias parameter to represent the level of confidence when incorporating customer input into the sizing machine learning model and apply this bias parameter in different phases for different purposes. One phase is the model building phase for the sizing machine learning model, and this purpose is to fine tune behavior of the sizing machine learning model. The next phase is the model using phase (e.g., inference phase), and this purpose is to change the returned result (e.g., output) of the sizing machine learning model at runtime as needed based on the customer input. For undetermined dimensions that require the suggested values from the sizing machine learning model, the system (e.g., a sizing evaluator module) uses an error rate to measure the difference between the value returned from the sizing machine learning model and the value returned from the existing sizing application, and the system selects/chooses the expected value based on a user-specified allowed_error_rate parameter.

The target system refers to the specific software or hardware environment for which the software sizing application is providing recommendations, and the recommendations are for software that is executed on computer resources of the target system. Example computer resources of the target system that may be utilized by the software are discussed below. The target system encompasses the entire infrastructure, including computational resources, network configurations, and storage systems that will support the specified workloads of the software. Example components of a target system may include any of the following: 1) Computational Resources: this includes central processing units (CPUs), graphic processing units (GPUs), memory (RAM), and other processing units that perform the computational tasks required by the software. 2) Storage Systems: this includes various types of storage devices such as hard drives, solid-state drives (SSDs), and network-attached storage (NAS) that store data required by the software. 3) Network Infrastructure: this includes network devices and configurations that facilitate communication between different components of the system, such as routers, switches, and network bandwidth. 4) Software Applications: this includes specific software applications and services that will run on the target system, including their configurations and dependencies. 5) Operating Systems and Middleware: the operating systems and middleware provide the runtime environment for the software applications. 6) Workload Characteristics: the nature of the workloads that the target system will support, including the type and volume of data processed, the number of concurrent users, and the performance requirements.

The target system is the focus of the software sizing application, which aims to provide accurate and optimized recommendations for resource allocation to ensure that the target system operates efficiently and meets performance and hardware constraints, in accordance with one or more embodiments.

One or more embodiments described herein can utilize machine learning techniques to perform tasks, such as classifying a feature of interest. More specifically, one or more embodiments described herein can incorporate and utilize rule-based decision making and artificial intelligence reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

Descriptions of various embodiments of the present disclosure are presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

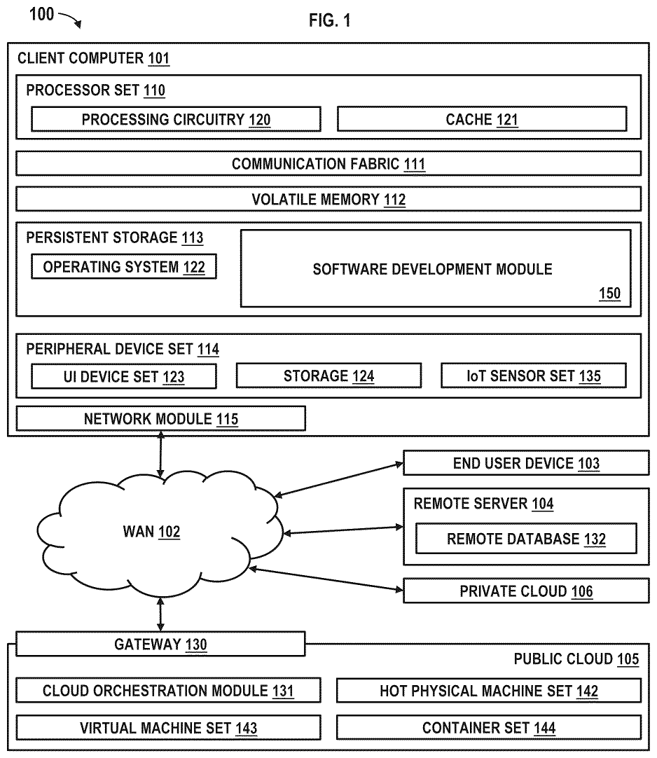

FIG. 1 illustrates a computing environment 100, according to an embodiment. Computing environment 100 contains an example of an environment for the execution of at least some of the computer code involved in performing the inventive methods, such as a software development module 150 for building a sizing machine learning model to output a sizing result for software and executing the sizing machine learning model that incorporates customer input (e.g., as feedback of the execution of software on a target system) in order to modify the software for execution of the target system. In addition to the software development module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and software development module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in software development module 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the software development module 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the oner of the entity is also updated).

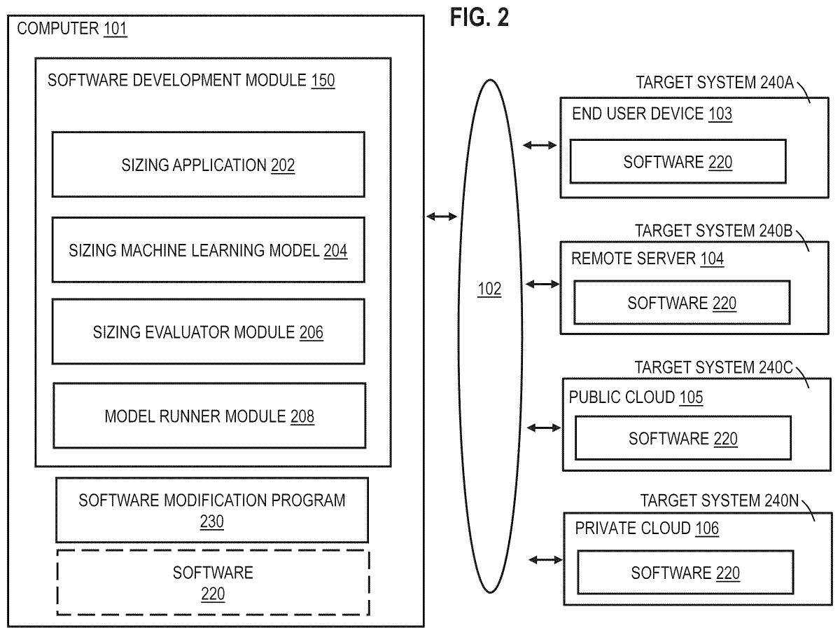

FIG. 2 depicts a block diagram of the computer 101 with further details for building a tunable sizing model for software sizing recommendations to modify software that operates on a target system (e.g., which includes one or more computer systems) in accordance with one or more embodiments. The software development module 150 may include and/or be coupled to a sizing application 202, a sizing machine learning model 204, a sizing evaluator module 206, and a model runner module 208. Example target systems of software 220 are illustrated by target system 240A representing, for example, the end user device 103, target system 240B representing, for example, the remote server 104, target system 240C representing, for example, the private cloud 105, and target system 240N representing, for example, the private cloud 106. The target systems 240A-240N can generally be referred to as target systems 240.

According to one or more embodiments, the software development module 150 can output sizing recommendations for software 220 operating a target system, such as one of the target systems 240. In one or more embodiments, the sizing recommendations can cause a human software developer to modify the software 220 to meet the sizing recommendations. In one or more embodiments, the sizing recommendations can be input to a software modification program 230 to cause the software modification program 230 to modify the software 220 to meet the sizing recommendations.

The computer 101 can transfer the modified software 220 to the target system, such as target system 240, for deployment on the target system. In response to the software development module 150 outputting the sizing recommendations to modify the software 220, the software 220 can be deployed and execute on any of the target systems 240 including the end user device 103, the remote server 104, the public cloud 105, and the private cloud 106. The software 220 executing on the target system 240 has been modified according to the sizing recommendation from the software development module 150, such that customer input is factored in the sizing recommendation. The customer input may be after running (a prior version) of the software 220 on the target system. The sizing recommendation may be used interchangeably with sizing result, sizing value, size, etc., which includes one or more values regarding the required computer resources for operating the software 220 on the target system 240. The categorization of the required computer resources in the sizing result may be referred to as dimensions.

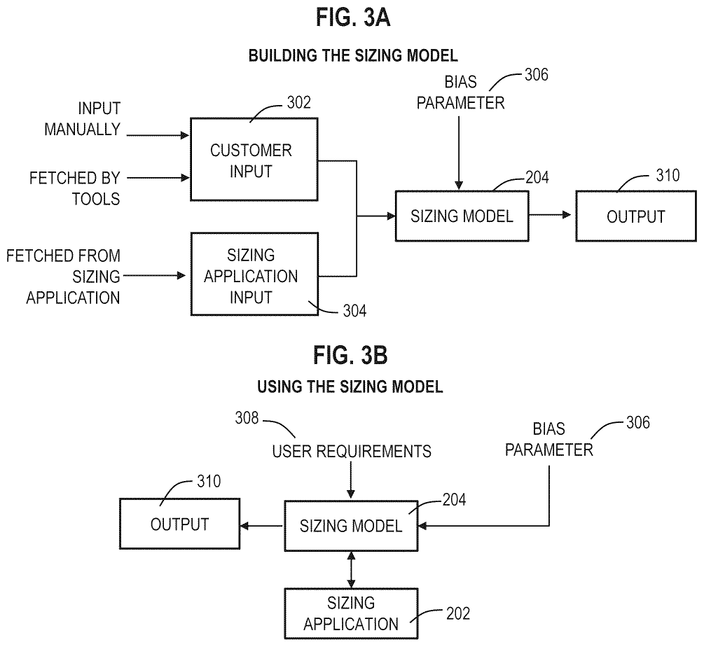

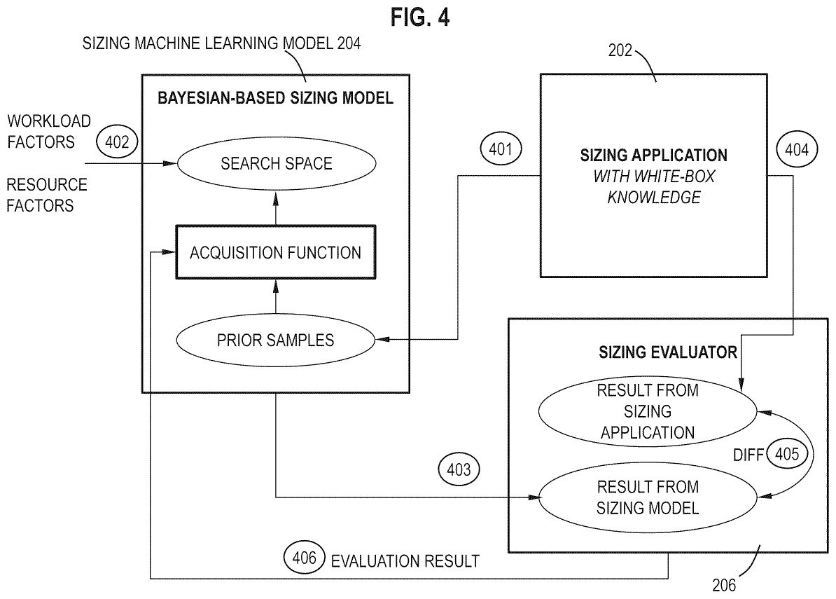

FIG. 3A depicts a flow diagram of building/training the sizing machine learning model in accordance with one or more embodiments. The software development module 150 is configured to input customer input 302, sizing application input 304, and a bias parameter 306 to the sizing machine learning model 204 as training data. The customer input 302 and the sizing application input 304 is for the software 220. In one or more embodiments, the customer input 302 may be manually input and/or fetched by one or more software tools. The customer may have been running the software 220 on a target system 240 and recognizes that changes are needed. In one case, too many computer resources of one type are being used, while computer resources of another type are left idle. The sizing application input 304 is generated by the sizing application 202. The bias parameter 306 is input to represent the level of confidence when incorporating the customer input 302 into the sizing machine learning model 204. The sizing machine learning model 204 is trained to generate output 310. The output 310 includes the values for sizing the software 220 for the target system 240. The output 310 is the sizing result or recommendations for the size of the software 220.

FIG. 3B depicts a flow diagram of using the sizing machine learning model for inference in accordance with one or more embodiments. The software development module 150 is configured to input user requirements 308 as the customer input, the output from the sizing application 202, and the bias parameter 306 to the sizing machine learning model 204 for inference. The output 310 of the sizing machine learning model 204 provides values for modifying the software 220, and the output 310 causes the software 220 to be modified and deployed on the target system 240 in order to more efficiently utilize the computer resources of the target system 240. As noted herein, the sizing recommendations can cause a human software developer to modify the software 220 to meet the sizing recommendations. In one or more embodiments, the sizing recommendations can be input to the software modification program 230 to cause the software modification program 230 to modify the software 220 to meet the sizing result of the output 310. This improves the functioning of the one or more computer systems that form the target system 240 because software 220 has been modified to reduce the use of computer resources of the target system 240, to utilize idle computer resources, to improve power usage, to reduce bandwidth usage, to reduce memory usages, etc.

The output 310 generated by the sizing machine learning model 204 is flexible such that the sizing logic is not hard-coded and that changes/adjustments (e.g., tunning) to sizing machine learning model 204 do not require a hard code change. Also, the output 310 generated by the sizing machine learning model 204 incorporates feedback from the customer (e.g., as customer/user input), when the customer has already deployed the software 220 for execution on a target system 240 and run the target system 240 for a considerable period. By utilizing the feedback loop from the customer, the sizing machine learning model 204 is configured to use the real environment data from different customers, in order improve the sizing machine learning model 204, as discussed in accordance with one or more embodiments.

Further, the sizing machine learning model 204 can be loaded to run as a proxy for the original sizing application 202. The sizing machine learning model 204 outputs the sizing result based on the customer/user input (which includes different requirements) and the bias parameter that indicates a confidence level (e.g., 0 to 1) of how the sizing machine learning model behave like the original sizing application.

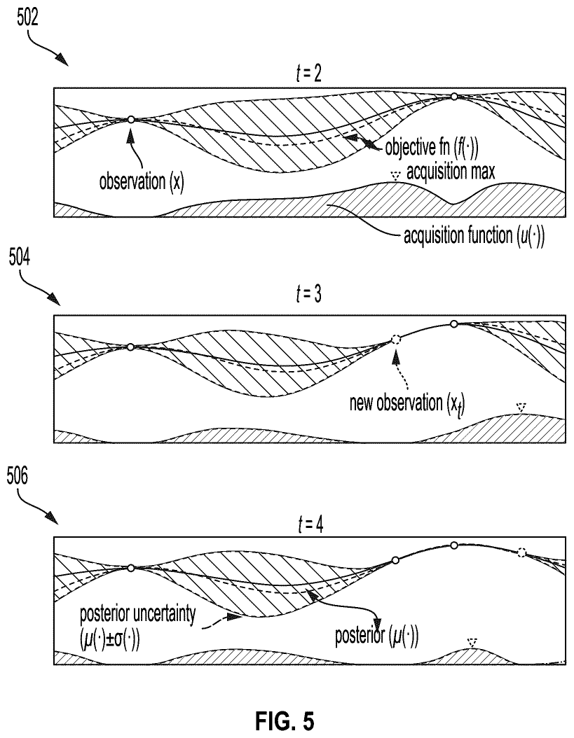

FIG. 4 depicts an example flow diagram of a procedure for building the sizing machine learning model to fit the sizing application according to one or more embodiments. FIG. 4 provides an example of the sizing machine learning model 204 utilizing an optimization algorithm. In one or more embodiments, the sizing machine learning model 204 may utilize Bayesian optimization algorithms. It should be appreciated that machine learning algorithms are not limited to Bayesian optimization algorithms and other suitable machine learning algorithms may be utilized.

In one or more embodiments, machine learning models discussed herein can include various engines/classifiers and/or can be implemented on a neural network. The features of the engines/classifiers can be implemented by configuring and arranging the computer 101 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets can be utilized to train the machine learning algorithms. The training datasets can include historical data of output from the sizing application, customer input, prior samples (discussed further herein), dimensions, etc. Labels can be applied to respective training data to train the machine learning algorithms, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

Referring to FIG. 4, at block 401, the sizing application 202 is configured to generate prior samples as initial input to the sizing machine learning model 204. The sizing application 202 can be any suitable sizing application known by one of ordinary skill in the art. The sizing application 202 includes white-box knowledge. White-box knowledge refers to a comprehensive understanding of the internal workings, structure, and implementation details of the system, software, or model. This type of knowledge is in contrast with black-box knowledge, where only the inputs and outputs are known, and the internal mechanisms are not visible or understood.

At block 402, the sizing machine learning model 204 is configured to receive input of workload factors and resource factors, which define the search space. The search space refers to the set of all possible solutions or configurations that can be explored to solve the particular problem. In the context of optimization or machine learning, the search space encompasses all the potential values or combinations of variables that can be considered to find the optimal or best solution. Particularly, the search space includes the various workload factors and resource factors that define the possible configurations for the sizing machine learning model 204. The search space is explored using optimization algorithms, such as Bayesian optimization, to find the best configuration that meets the desired criteria.

For example, in the software sizing application and/or the sizing machine learning model, the search space might include dimensions such as the number of hosts, the number of applications, the number of worker nodes, and the number of storage nodes. The dimensions are the computer resources of the target system 240, which may be utilized by the software 220. Each of these dimensions has a specified range of possible values, and the optimization process explores this search space to find the optimal configuration for computer resource allocation. The sizing result is to provide values for the dimensions, such that the software 220 is modified to utilize the determined values for the dimensions. In one or more embodiments, the values of one or more dimensions may be known/given prior to executing the sizing machine learning model and one or more dimensions may be unknown. As such, with input of the known dimensions to the sizing machine learning model 204, the sizing machine learning model 204 is configured to output values of the unknown dimensions in the sizing result.

Returning to FIG. 4, at block 403, the sizing machine learning model 204 is configured to run the acquisition function against the search space to generate the sizing result as the output from the sizing machine learning model 204. The sizing result is input to the sizing evaluator module 206 from the sizing machine learning model 204.

The acquisition function is a component in optimization algorithms, particularly in Bayesian optimization, used to guide the search for the optimal solution within the search space. The acquisition function determines the next point to evaluate by balancing exploration (e.g., searching new areas of the search space) and exploitation (e.g., refining known good areas). In particular, the acquisition function is used to guide the optimization process for building the sizing machine learning model. It helps in selecting the most promising configurations of workload and resource factors to evaluate, ensuring that the model converges efficiently to an optimal solution that provides accurate and effective sizing recommendations.

At block 404, the sizing application 202 is configured to generate a sizing result and input the sizing result to the sizing evaluator module 206. The sizing result from the sizing application 202 is the same input that is also fed into the sizing machine learning model 204.

At block 405, the sizing evaluator module 206 is configured to calculate the difference between the two sizing results (e.g., the sizing result from the sizing application 202 and the sizing result from the sizing machine learning model 204) as the evaluation result.

At block 406, the sizing evaluator module 206 is configured to send the evaluation result back to the acquisition function to impact its behavior next time/iteration. The software development module 150 is configured to execute blocks 403, 404, and 405 iteratively until a predefined stop criteria is reached such as, for example, the maximum number of iterations is reached, or until some convergence threshold is met. Then, the software development module 150 finishes the model building of the sizing machine learning module 204, thereby resulting in a trained machine learning model.

It should be appreciated that procedure of the software development module 150 is efficient because the sizing application 202 provides the sizing result based on its white-box knowledge, which is very fast, as compared to the regular approach to obtain the similar result by running the real system for the evaluation. When building the sizing machine learning model 204, the software development module 150 uses the optimization process but does not solve it as an optimization problem. Instead, embodiments explore the search space, so the resulting sizing machine learning model is more accurate. To call the sizing application automatically during the procedure, the sizing application exposes its REST APIs.

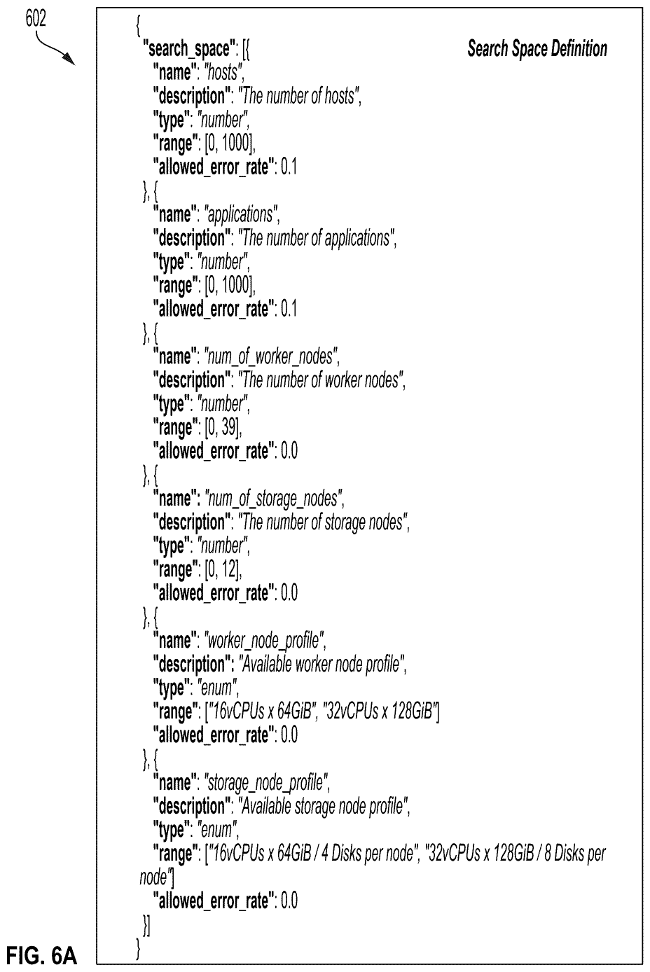

FIG. 5 depicts example details regarding the acquisition function according to one or more embodiments. FIG. 5 depicts diagrams of building the sizing machine learning model according to one or more embodiments. The diagrams 502, 504, and 506 depict the optimization process where the acquisition function u(·) (e.g., of the sizing machine learning model 204) suggests the optimal value based on the acquisition max (e.g., the red triangles) it calculates in each iteration. Then, the new observation (e.g., the red points xₜ) gives the evaluation result about how well the suggested value performs. This process helps to shape the sizing machine learning model 204 to approximate the original sizing application more and more after each iteration. The diagram 502 is at time t=2, the diagram 504 is at time t=3, and the diagram 506 is at time t=4.

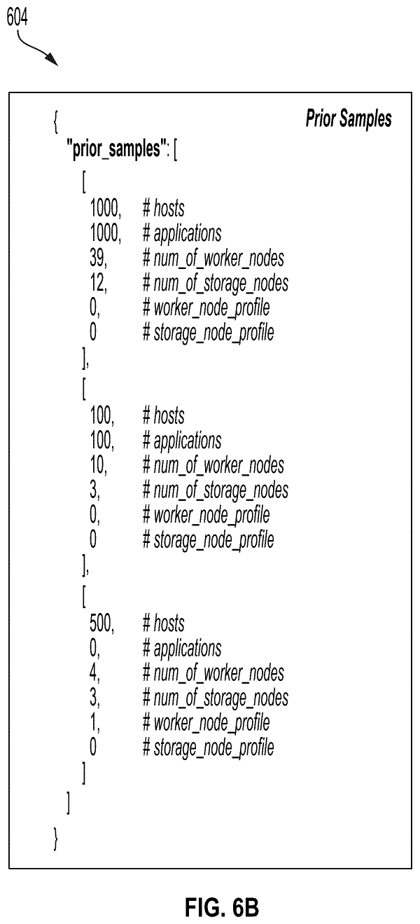

FIG. 6A depicts example details regarding the search space when building the sizing machine learning model to fit (or match) the sizing application according to one or more embodiments. In FIG. 6A, block 602 depicts the search space definition, which defines the search space including multiple dimensions. Each dimension maps to a factor including name, value type, range, and allowed error rate (which will be discussed later). If the allowed error rate is not given, the default value is unlimited in one or more embodiments. Block 602 provides a sample snippet of the search space definition with various dimensions. In FIG. 6B, block 604 depicts a sample snippet of an example of prior samples. In block 604, the prior samples are the initial inputs (e.g., dimensions) when starting to build the sizing machine learning model 204. The prior samples include a list of multidimensional vectors, and each dimension has a value that follows what is defined in the search space.

Now turning to the cost function of the sizing evaluator module 206, this is to define the cost function and use it to evaluate the sizing result created by the sizing machine learning model 204 in each iteration. Evaluating the sizing result from the sizing machine learning model 204 is done by calculating the vector distance between the point sampled by the sizing machine learning model 204 from the search space and the point retrieved from the sizing application 202 via REST API call. For example, the two points are two vectors with multiple dimensions, and the number of dimensions are the same for each vector. One point comes from the sizing machine learning model 204 and the other point comes from the sizing application 202. Below is an example of how the cost function can be expressed:

$$Y = f ( X ) \qquad ( Eq . 1 )$$

$$D = F ( X , {Y}^{′} ) = \vert {Y}^{′} - f ( X ) \vert = \vert {Y}^{′} - Y \vert \qquad ( Eq . 2 )$$

The Eq. 1 models how the sizing application 202 behaves, where X represents the input to the sizing application 202 such as, for example, the specified workloads. Y is the output from the sizing application 202, for example, the suggested resources to support the workloads. Both X and Y are multidimensional vectors.

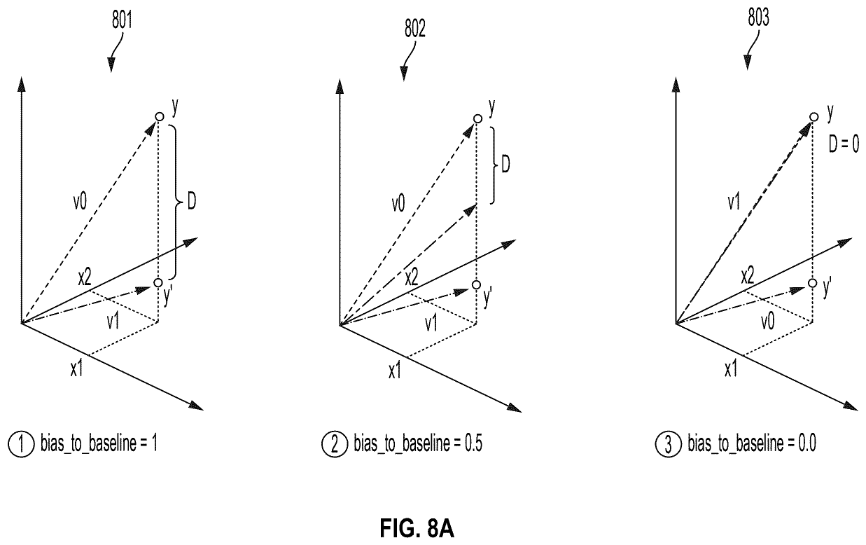

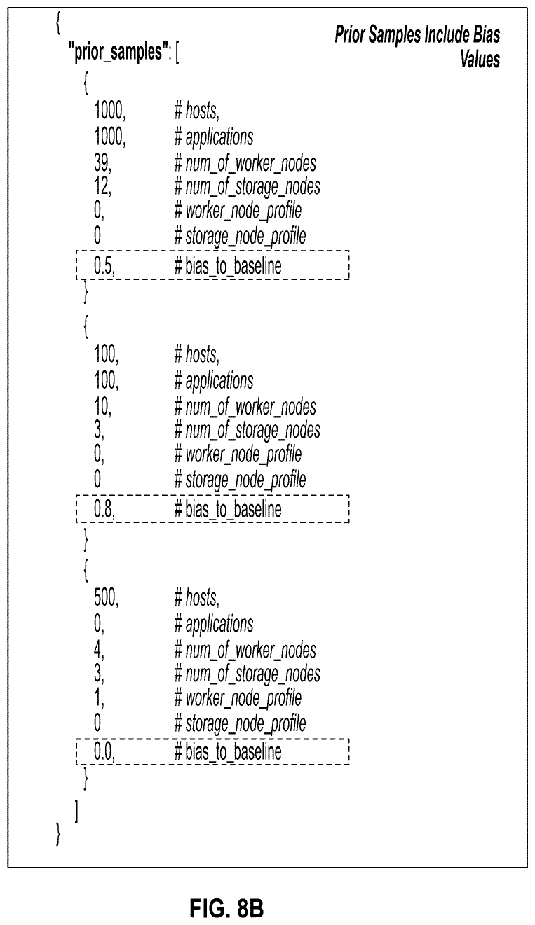

The Eq. 2 is the cost function. The cost function (Eq. 2) relies on Eq. 1 to calculate Y given X, and then the sizing evaluator module 206 asks the sizing machine learning model 204 to get the suggested Y, (e.g., Y′). Finally, sizing evaluator module 206 is configured to calculate the distance between Y and Y′ to evaluate how close the two vectors are. The closer the two vectors are, the smaller the distance value D will be. If the distance is 0 (e.g., view 803 in FIG. 8A), this means the value suggested by the sizing machine learning model 204 perfectly matches the value returned by the sizing application 202, and vice versa. At this point, the goal is to keep the cost function value as small as possible, so that the sizing machine learning model 204 being built can match the sizing application 202 as much as possible.

Discussion is now turned to incorporating the customer input via the bias parameter. Building the sizing machine learning model 204 that matches the original sizing application as much as possible is not the final goal; this is just the baseline. The real goal/target is to incorporate customer input into this baseline in a controlled manner, to tune this baseline. To do so, the software development module 150 introduces the bias parameter to indicate to what extent the sizing machine learning model 204 leans towards the existing sizing application 202 or not. The bias parameter (e.g., named as bias_to_baseline) may be in a range of values from 0 to 1 (e.g., [0,1]), where 1 means the sizing machine learning model 204 is fully identical to the existing sizing application 202 and where 0 means the sizing machine learning model 204 ignores the sizing application completely. This bias parameter acts as a tuning parameter to tune the internal calculation of the sizing machine learning model to control its behavior and make it either close to or far from the existing sizing application 202.

There are two phases that the bias parameter can be introduced: model building phase versus model using phase. If the bias parameter is introduced in the model building phase (e.g., in FIG. 3A), then the bias value of the bias parameter is determined when the sizing machine learning model 204 is being built. Once the model building is finished, the sizing machine learning model 204 is specifically designed/tuned to provide the sizing result for this (particular) bias value as the bias parameter. In this case, the operator cannot tune the model using a new bias parameter unless the sizing machine learning model 204 is re-built. This is particularly valuable when one has a baseline defined by sizing application 202 and wishes to fine tune it by incorporating customer input. This may be analogous to LLM fine tuning.

On the other hand, if the bias parameter is introduced in the model using/inference phase (e.g., in FIG. 3B), then the operator is allowed to specify the bias value of the bias parameter at runtime when requesting the sizing machine learning model 204 to output the sizing result. This can impact the sizing model suggestion, without changing the sizing machine learning model 204 itself. This may be analogous to LLM prompt tuning.

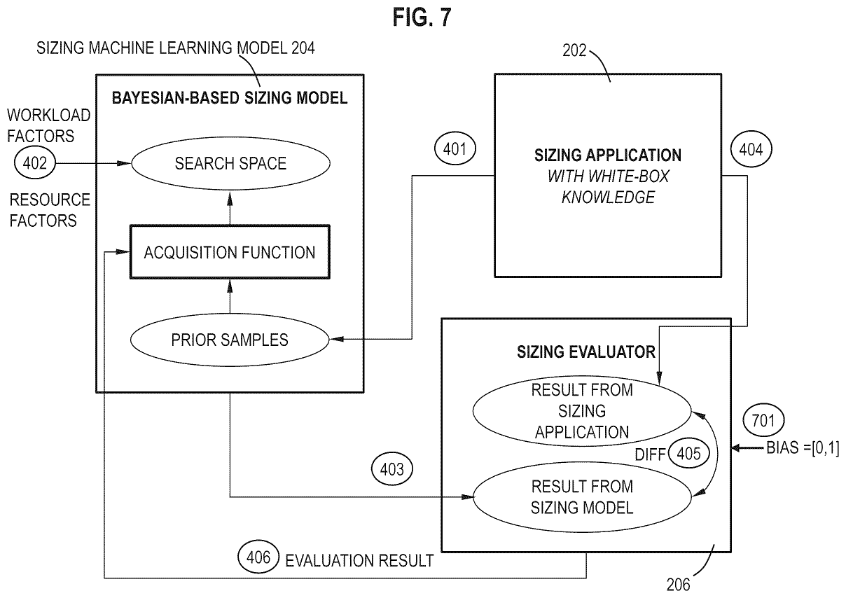

Further discussion turns to introducing the bias parameter when building the sizing machine learning model and next discussion will provide further details when using the sizing machine learning model. When introducing the bias parameter into the model building phase as depicted at block 701 in FIG. 7, the bias parameter is involved in the cost calculation of the optimal points sampled in each iteration. If the sampled point comes from a customer input, the vector distance between the sampled point from the sizing machine learning model and the point from the sizing application is tuned by the bias parameter using the following formula.

$$D = b \times F ( X , {Y}^{′} ) = b \times \vert {Y}^{′} - f ( X ) \vert = b \times \vert {Y}^{′} - Y \vert \qquad ( Eq . 3 )$$

The bias value of the bias parameter is in the range of [0, 1]. When b is 1, this means (the output of) the sizing machine learning model 204 is fully identical to (the output of) the existing sizing application 202, so the distance D is equivalent to the one before the bias parameter is introduced. When b is 0, the distance D will always be 0; this means the distance is fully impacted by the customer input.

To further demonstrate the cost calculation impacted by the bias parameter, FIG. 8 depicts graphs with a three-dimensional (3D) vector [x1, x2, y] as an example, where x1 and x2 are two workload factors, while y is a resource factor. The sizing application provides the operator with y, given x1 and x2; the sizing machine learning model 204 provides the operator with y′, given the same x1 and x2. D is the distance between the two vectors: v0=[x1, x2, y], v1=[x1, x2, y′]. When the bias value is 1 as depicted in view 801, D is the actual distance between v1 and v0. When bias value is 0.5 as depicted in view 802, D is multiplied by 0.5 as if the distance is shortened. When bias value is 0.0 as depicted in view 803, D becomes 0, which means v1, suggested by the sizing machine learning model 204, is the best suggestion. Ultimately, such tuning impacts how the sizing machine learning model 204 fits the original sizing application 202, as if what its fit is not the actual sizing application 202, but instead a tuned sizing application 202, which includes some custom feedback. This achieves the desired goal.

When specifying the bias parameter, it can be a unique constant value or a value that can be variant for each prior sample that is collected as customer input. For example, the sample snippet of the prior samples depicted in FIG. 8B includes an additional factor which is the bias_to_baseline value that is variant for each prior sample. As noted herein, the bias_to_baseline value is the bias parameter.

Discussion turns to further details of introducing the bias parameter when using the sizing machine learning model. To introduce a bias parameter into the model using/inferencing phase, the software development module 150 firsts builds a sizing machine learning model 204 that sets the bias_to_baseline to 0 (e.g., bias parameter=0). This means that, if the value suggested by the sizing machine learning model 204 is a customer input, the software development module 150 (e.g., the sizing evaluator module 206) takes the value suggested by the sizing machine learning model 204 as an optimal value without considering the counterpart value returned from the sizing application 202 (e.g., D=0). If the value suggested by the sizing machine learning model 204 is not a customer input, then the software development module 150 is configured to fall back to the regular distance calculation (for D).

When using the sizing machine learning model 204 to provide the suggestion, the sizing evaluator module 206 makes one API call to the sizing machine learning model 204, makes another API call to the sizing application 202, and then aggregates the sizing results from the two sides, weighted by a (user specified) bias parameter, using the following formula.

$$V = b \times V 0 + ( 1 - b ) \times V 1 \qquad ( Eq . 4 )$$

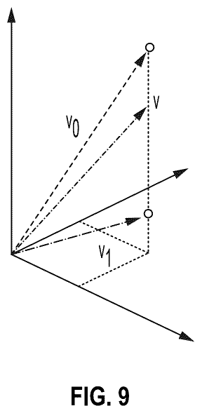

V₀ is the result returned from the sizing application 202, which is the baseline. V₁ is the result returned from the sizing machine learning model 204 that was built. The b is the bias_to_baseline parameter (e.g., bias parameter). FIG. 9 depicts a graph illustrating a 3D vector [x1, x2, y] as an example where x1 and x2 are two workload factors while y is a resource factor. The vector Vis a weighted aggregation of vector V₀ and V₁.

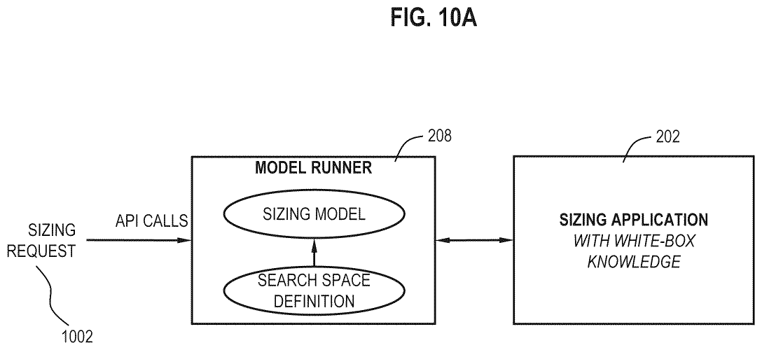

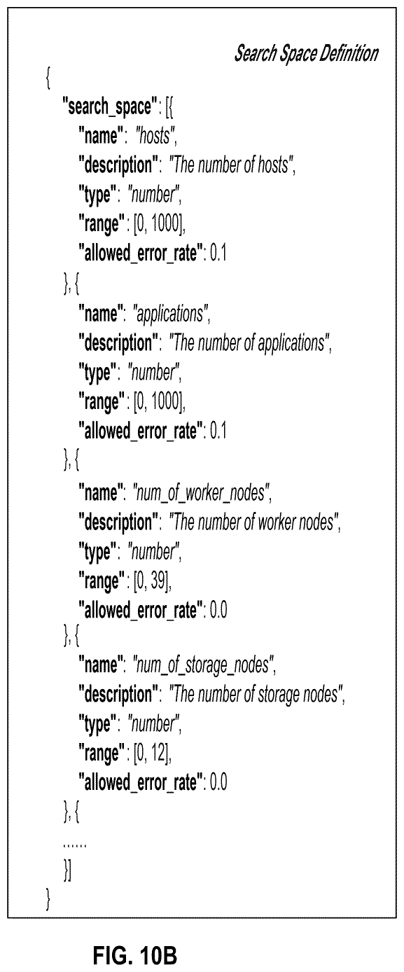

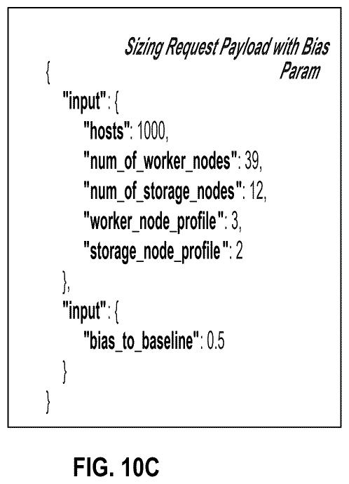

Not turning to further details regarding executing the sizing machine learning model 204, in one or more embodiments a model runner module 208 may be utilized as depicted in FIG. 10A. The model runner module 208 is configured to first load the sizing machine learning model 204 along with the search space definition, and then serve a sizing request 1002 via an API call. The model runner module 208 is configured to keep the connection with the original sizing application 202 in order to call the sizing application 202 when needed. A sizing request 1002 includes the values of all known dimensions and asks for the suggestion of the remaining unknown dimensions. Optionally, the sizing request 1002 can also include the bias parameter for the operator to control the suggestion at runtime. In one or more embodiments, the sizing request 1002 may be received by the software development module 150 in order to modify the software 220 and/or cause the modification of the software 220 accordingly for execution on the target system 240.

The allowed_error_rate value for each dimension defined in the search space definition is used to control how much error rate an operator can accept, when the suggestion (or sizing result) provided by the sizing machine learning model 204 is different from the suggestion (or sizing result) provided by the sizing application 202. Setting the allowed_error_rate to 0.0 means no tolerance, for example, the suggestion of the sizing machine learning model 204 should exactly match the sizing application's suggestion (e.g., the operator may be sensitive to the number of worker nodes due to their considerable cost). If the allowed_error_rate is not specified, this means the operator is fine with any suggested value from the sizing machine learning model 204. FIG. 10B depicts an example search space definition, and FIG. 10C depicts an example sizing request payload with a bias parameter.

The model runner module 208 works as a proxy for the sizing application 202. When operator asks for a sizing suggestion, the model runner module 208 is configured to determine whether to delegate the call to the sizing application 202 or the sizing machine learning model 204, which depends on the type of user requests, allowed error range, etc. For example, if the operator asks for the (number of) supported workloads given available computer resources and budget, the model runner module 208 provides the suggestion using the sizing machine learning model 204 directly. If the operator asks for a needed computer resource to support the given workload, then based on an error range that can be configured, the model runner module 208 may delegate the call to the sizing application 20 to return the suggestion. When using the sizing machine learning model 204, embodiments use an optimization process too, and this time it is a real optimization problem.

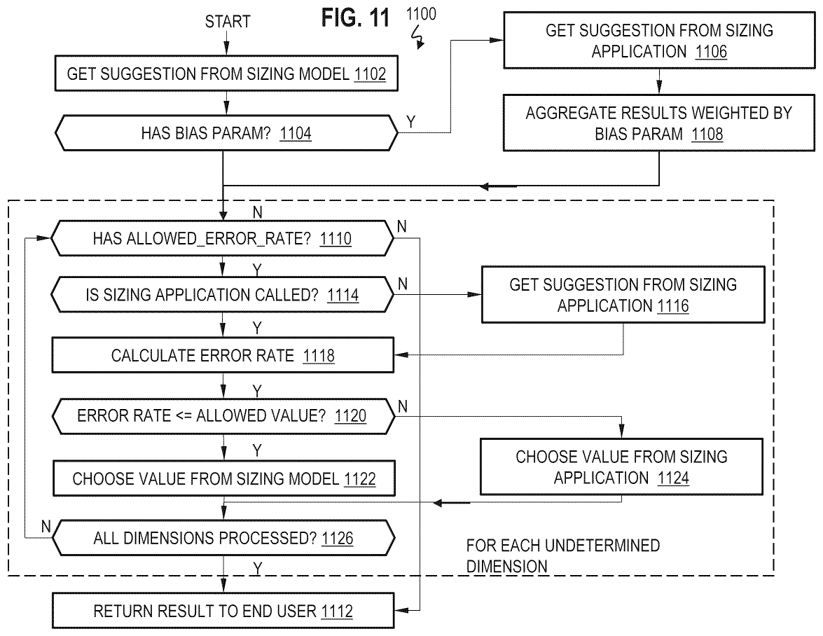

FIG. 11 depicts a flowchart of a computer-implemented method 1100 for operating the model runner module 208 according to one or more embodiments. At block 1102, the model runner module 208 is configured to call the sizing machine learning model 204 to get the suggestion or sizing result for the undetermined dimensions. At block 1104, the model runner module 208 is configured to check if the operator specifies the bias_to_baseline parameter in the sizing request. At blocks 1106 and 1108, if the bias_to_baseline parameter is present, the model runner module 208 is configured to call the sizing application 202 to get another suggestion or sizing results and aggregate the two suggestions/results weighted by the bias_to_baseline parameter. The process goes to the next operation.

The flow starts a loop to iterate all undetermined dimensions. At blocks 1110, when the bias_to_baseline parameter is not present and/or after block 1108, the model runner module 208 is configured to, for each undetermined dimension, check the search space definition if the allowed_error_rate is defined. At block 1112, when the allowed_error_rate is not included, the model runner module 208 is configured to return the result to operator and finish the flow.

At block 1114, when the bias_to_baseline parameter is present, the model runner module 208 is configured to check if the sizing application 202 is called. At block 1116, the model runner module 208 is configured to call the sizing application 202 to get the suggestion or sizing result from the sizing application 202 if the suggestion has not been received.

At blocks 1118 and 1120, the model runner module 208 is configured to calculate the actual error rate by checking the two suggestions/results (e.g., obtaining the difference between the suggestion or sizing result from the sizing application 202 and the suggestions or sizing result for the sizing machine learning module 204) and to check if the error rate is less than or equal to an allowed_error_rate. The allowed_error_rate may be predetermined in advance.

At block 1122, when the error rate is less than or equal to allowed_error_rate, the model runner module 208 is configured to choose the suggested value output from the sizing machine learning model. At block 1124, when the error rate is less than or equal to allowed_error_rate, the model runner module 208 is configured to choose the suggested value from the sizing application 202. At block 1126, the model runner module 208 is configured to check if all undetermined dimensions are processed as above. At block 1112, when all undetermined dimensions are processed, the model runner module 208 is configured to return the sizing result to operator and finish the flow. Otherwise, the flow returns to block 1110 when more dimensions are to be processed.

Further regarding the error rate calculation, based on the error rate of each undetermined dimension, the model runner module 208 is configured to decide how to compose the result for the operator as below:

1) If the allowed_error_rate is 0, this means the operator does not tolerate any error, and the software development module 150 is to return an accurate value for that dimension. In that case, the model runner module 208 calls the sizing application 202 and returns the result from sizing application 202 to operator.

2) If the allowed_error_rate is not 0, this means the operator can tolerate the actual error rate falling into a specified range for that dimension. In that case, the model runner module 208 takes the results from both the sizing machine learning model 204 and the sizing application 202 and calculates the difference between the two results for each undetermined dimension. When the calculated difference is within the allowed error rate, then the value from the sizing machine learning model 204 is output as the result. When the calculated difference is not within the allowed error rate, the value from the sizing application 202 is output as the result.

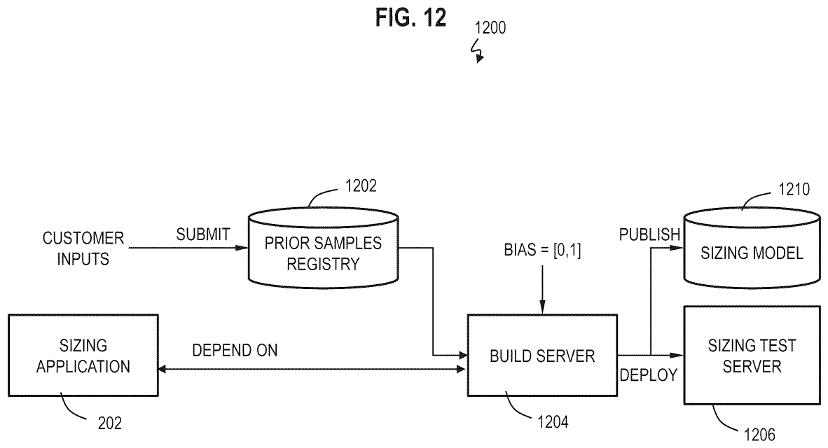

FIG. 12 depicts a block diagram for continuously maintaining the sizing machine learning model according to one or more embodiments. When considering the sizing application 202 and considering that the customer inputs (e.g., feedback) can be changed, FIG. 12 illustrates a pipeline 1200 structured to update the sizing machine learning model 204 regularly. For example, the pipeline 1200 can be triggered at any predetermined time period or interval (e.g., every two weeks) because the sizing application 202 can be released every two weeks. Each time the pipeline 1200 is initiated/invoked, the sizing machine learning model 204 is re-built. During the time period or interval, newly collected customer input (e.g., the most updated feedback) can be added as new prior samples (e.g., in a repository 1202 of prior samples) into the sizing machine learning model 204 as well.

In one or more embodiments, the sizing machine learning model 204 has been built and is being maintained/updated to generate an updated sizing result for the software 220, such that the software 220 is configured to accommodate the computer resources of a target system 240 that runs the software 220. Customer input is received as feedback after executing the software 220 on the target system 240 (e.g., of customer) for a predetermined time. The customer input may be stored in the repository 1202 as the most recent prior samples to be utilized to update (e.g., further train) the sizing machine learning model 204 along with input of a bias parameter. While executing on a build server 1204 (e.g., one or more computers 101), the updating is performed by inputting to the sizing machine learning model 204 output from the sizing application 202, the customer input from the repository 1202, and the bias parameter, which further trains the sizing machine learning model 204. The updated sizing machine learning model 204 may be deployed to a sizing test server 1206 for testing and published to a repository 1210.

The sizing results of the (updated) sizing machine learning model 204 can be utilized to modify the software 220, and the modified software 220 is transferred and executed on the target system 240. Accordingly, this has the technical effect of causing the target system 240 to use a different amount (e.g., fewer or more) of computer resources according to the values in the sizing result for each of the dimensions.

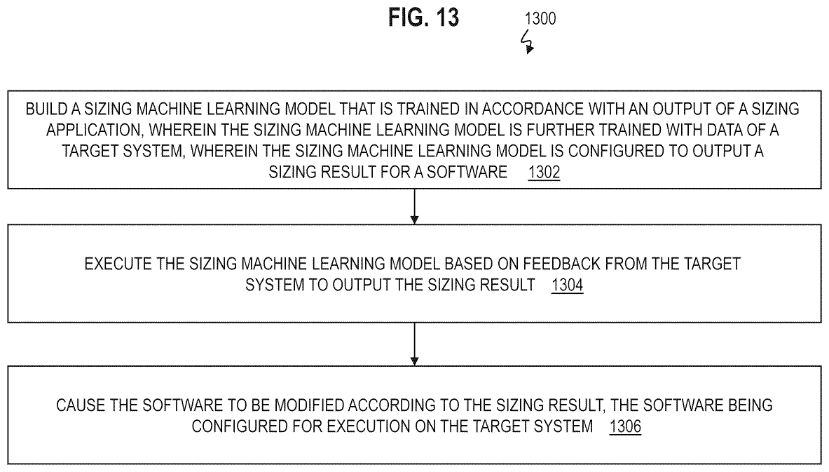

FIG. 13 depicts a flowchart of a computer-implemented method 1300 for building a tunable sizing model for outputting a software sizing recommendation to modify software to operate on computer systems according to one or more embodiments. Reference can be made to any figures discussed herein.

At block 1302 of computer-implemented method 1100, the software development module 150 is configured to build a sizing machine learning model 204 that is trained in accordance with an output of a sizing application 202, where the sizing machine learning model 204 is further trained with data of a target system 240, where the sizing machine learning model 204 is configured to output a sizing result for (modifying) a software 220.

At block 1304, the software development module 150 is configured to execute the sizing machine learning model 204 based on feedback from the target system 240 to output the sizing result.

At block 1306, the software development module 150 is configured to cause the software 220 to be modified according to the sizing result, the software 220 being configured for execution on the target system 240.

The sizing machine learning model 204 receives input of a bias parameter. A bias parameter indicates a confidence when incorporating the feedback from the target system 240 into the sizing machine learning model 204. The sizing result includes dimensions that are associated with execution of the software 220. The sizing result includes dimensions that correspond to a modification to the software 220 in order to change an amount of computer resources required by the target system 240 to execute the software 220.

The feedback from the target system 240 is configured to modify the sizing result output from the sizing machine learning model 204 to meet computer resources of the target system 240, and logic of the sizing application 202 is hard-coded. The sizing application 202 outputs a second sizing result such that an error rate is a difference between the sizing result and the second sizing result, and the sizing result is selected in response to the error rate meeting an allowed error rate.

This present disclosure improves the functioning of a computer by a tunable sizing machine learning model outputting a sizing result that incorporates customer input (e.g., feedback from executing the software on a target system), using for the sizing result to modify the software, and executing the modified software on the target system. This optimizes/modifies the software for execution on the target system, thereby providing a more efficient and accurate execution of the modified software on the target system, such that the modified software aligns with or meets the computer resources of the target system. This targeted approach can reduce the overall computer resources required to be utilized on the target system when the software is executing and improve overall system performance. This leads to electronic devices that are efficient at handling the workload of the software.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
building a sizing machine learning model that is trained in accordance with an output of a sizing application, wherein the sizing machine learning model is further trained with data of a target system, wherein the sizing machine learning model is configured to output a sizing result for a software;
executing the sizing machine learning model based on feedback from the target system to output the sizing result; and
causing the software to be modified according to the sizing result, the software being configured for execution on the target system.

2. The computer-implemented method of claim 1, wherein the sizing machine learning model receives input of a bias parameter.

3. The computer-implemented method of claim 1, wherein a bias parameter indicates a confidence when incorporating the feedback from the target system into the sizing machine learning model.

4. The computer-implemented method of claim 1, wherein the sizing result comprises dimensions that are associated with the execution of the software.

5. The computer-implemented method of claim 1, wherein the sizing result comprises dimensions that correspond to a modification to the software in order to change an amount of computer resources required by the target system to execute the software.

6. The computer-implemented method of claim 1, wherein:
the feedback from the target system is configured to modify the sizing result output from the sizing machine learning model to meet computer resources of the target system; and
logic of the sizing application is hard-coded.

7. The computer-implemented method of claim 1, wherein:
the sizing application outputs a second sizing result such that an error rate is a difference between the sizing result and the second sizing result; and
the sizing result is selected in response to the error rate meeting an allowed error rate.

8. A system comprising:
a memory comprising computer readable instructions; and
a processing device for executing the computer readable instructions, the computer readable instructions controlling the processing device to perform operations comprising:
building a sizing machine learning model that is trained in accordance with an output of a sizing application, wherein the sizing machine learning model is further trained with data of a target system, wherein the sizing machine learning model is configured to output a sizing result for a software;
executing the sizing machine learning model based on feedback from the target system to output the sizing result; and
causing the software to be modified according to the sizing result, the software being configured for execution on the target system.

9. The system of claim 8, wherein the sizing machine learning model receives input of a bias parameter.

10. The system of claim 8, wherein a bias parameter indicates a confidence when incorporating the feedback from the target system into the sizing machine learning model.

11. The system of claim 8, wherein the sizing result comprises dimensions that are associated with the execution of the software.

12. The system of claim 8, wherein the sizing result comprises dimensions that correspond to a modification to the software in order to change an amount of computer resources required by the target system to execute the software.

13. The system of claim 8, wherein:
the feedback from the target system is configured to modify the sizing result output from the sizing machine learning model to meet computer resources of the target system; and
logic of the sizing application is hard-coded.

14. The system of claim 8, wherein:
the sizing application outputs a second sizing result such that an error rate is a difference between the sizing result and the second sizing result; and
the sizing result is selected in response to the error rate meeting an allowed error rate.

15. A computer program product comprising:
a set of one or more computer-readable storage media;
program instructions, collectively stored in the set of one or more storage media, for causing a processor set to perform computer operations comprising:
building a sizing machine learning model that is trained in accordance with an output of a sizing application, wherein the sizing machine learning model is further trained with data of a target system, wherein the sizing machine learning model is configured to output a sizing result for a software;
executing the sizing machine learning model based on feedback from the target system to output the sizing result; and
causing the software to be modified according to the sizing result, the software being configured for execution on the target system.

16. The computer program product of claim 15, wherein the sizing machine learning model receives input of a bias parameter.

17. The computer program product of claim 15, wherein a bias parameter indicates a confidence when incorporating the feedback from the target system into the sizing machine learning model.

18. The computer program product of claim 15, wherein the sizing result comprises dimensions that are associated with the execution of the software.

19. The computer program product of claim 15, wherein the sizing result comprises dimensions that correspond to a modification to the software in order to change an amount of computer resources required by the target system to execute the software.

20. The computer program product of claim 15, wherein:
the feedback from the target system is configured to modify the sizing result output from the sizing machine learning model to meet computer resources of the target system; and
logic of the sizing application is hard-coded.
